(19) United States
(12) Patent Application Publication
(10) Pub. No.: US 2026/0225415 A1
(43) Pub. Date: Aug. 6, 2026

(54) REMOVABLE COUPLER THEFT DETERENT FOR TRAILERS

(71) Applicants: Michael Teso, Fillmore, IN (US); Jeremy Deaton, Mt. Pleasant, TX (US); Harpreet Shaunki, Indianapolis, IN (US); Johnathan Bradley, Mt. Pleasant, TX (US)

(72) Inventors: Michael Teso, Fillmore, IN (US); Jeremy Deaton, Mt. Pleasant, TX (US); Harpreet Shaunki, Indianapolis, IN (US); Johnathan Bradley, Mt. Pleasant, TX (US)

(73) Assignee: Liberty Industries Investments, LLC d/b/a Liberty Trailers, Fillmore, IN (US)

(21) Appl. No.: 19/439,325

(22) Filed: Jan. 3, 2026

Related U.S. Application Data
(60) Provisional application No. 63/741,494, filed on Feb. 3, 2025.

(51) Int. Cl. B60D 1/52; E05B 65/00

(52) U.S. Cl. CPC B60D 1/52; E05B 65/00

(57) ABSTRACT

A theft-resistant coupling system for a trailer having a tongue includes a hitch receiver configured to receive a vehicle-engaging member for coupling the trailer to a vehicle. A coupler is receivably matable with the hitch receiver. The coupler includes a proximal portion and a distal portion. A blocking member is coupled to the distal portion that is substantially incapable of being functionally mated to a vehicle-engaging member, thereby preventing the vehicle from safely towing the trailer. A lock is movable between a locked position for locking the coupler to the hitch receiver and an unlocked position for permitting the coupler to be removed from the hitch receiver.

### CROSS-REFERENCE TO RELATED APPLICATIONS

The instant application claims the benefit of U.S. Provisional Patent Application No. 63/741,494, filed on Jan. 3, 2025, to Michael Teso, and entitled ‘REMOVABLE COUPLER THEFT DETERRENT FOR TRAILERS,’ which is fully incorporated herein by reference.

### BACKGROUND OF THE INVENTION

Millions of pull-behind trailers currently exist in the United States. These pull-behind trailers have a wide variety of different configurations and sizes. These trailers include recreational vehicle trailers, utility trailers, box trailers, cargo trailers, and the like.

Such trailers span both recreational vehicle type trailers and trailers designed to carry cargo, freight, live animals, and the like.

One problem with most pull-behind trailers is that they are easily stolen. They are easily stolen because they usually are not powered, which thereby eliminates the need for the thief to have a key or ignition bypass system to enable the thief to start the trailer to steal it. Rather, all the thief needs to do is to hook up the trailer to his vehicle and tow it away.

This action is simplified by the fact that most trailers have a universal coupling system for coupling them to a tow vehicle. On semi-trailers, a kingpin is employed to couple a trailer to a semi-tractor.

For larger recreational vehicles and trailers of the gooseneck type, a gooseneck coupler is used. A gooseneck coupler usually incorporates a coupler that has a ball receiver at its distal end. The ball receiver mates with a ball that is coupled to a gooseneck coupler receiver, which comprises a frame having a ball that is fixedly coupled to the bed of a pick-up truck or similar vehicle.

Another popular coupler is a pintle coupler. A pintle-type coupler is usually used on larger trailers and heavier-duty vehicles, such as dump trucks, utility-company trucks, and military vehicles that are used to pull heavy trailers that are used to carry heavy equipment such as backhoes, military vehicles, trench diggers, excavators, trailer-mounted wood chippers, small bulldozers, and similar heavy items.

The most popular form of hitch for use by the general public is the ball hitch that is used to tow a wide variety of trailers, such as flatbed trailers, utility trailers, recreational vehicle trailers, boat trailers, cargo trailers such as one might rent from a U-Haul® dealer, and animal trailers. Most lighter-weight utility vehicles, such as automobiles and pick-up trucks, are designed to use ball hitch trailers.

One difficulty that is faced by the owners of all types of trailers is theft. As the hitch systems described above are generally universal, it is quite easy for the owner of a vehicle having a ball hitch to couple his vehicle to a trailer regardless of whether it is his trailer or a trailer that he intends to purloin from a third party.

Obviously, this type of theft results in a significant loss to the trailer owner. Not only does the trailer owner lose the value of the trailer, but he may also lose the value of the cargo contained on the trailer. The value of the stolen cargo can very well significantly exceed the value of the stolen trailer.

Therefore, it is highly desirable to incorporate features on a trailer that help to make it theft resistant. It is an object of the present invention to provide a device which makes it more difficult for thieves to steal a trailer.

In this regard, it will be appreciated that no device is fully capable of ensuring that a trailer cannot be stolen at all. Rather, an object of the device of the present invention is to make it more difficult to steal a particular trailer, to thereby lower the likelihood that the trailer will be stolen.

In some cases, this lower likelihood is achieved because the thief will be discouraged from stealing this trailer, or any other trailer, because he or she may not have the tools or knowledge to overcome and defeat the theft-resistant features of the present invention, or one like it.

In other cases, theft resistance is achieved by making the trailer more difficult to steal than other trailers, to thereby discourage the thief from stealing the trailer which bears the present invention but instead causes the thief to choose to steal a trailer without the present invention that does not incorporate the theft-resistant features of the present invention.

These trailers may feature tongues constructed from various structural configurations, including but not limited to tubular, channel, I-beam, or box-section designs, and from materials such as steel, galvanized steel, aluminum, composites, or high-strength plastics (e.g., the 2DPA-1 polymer developed by MIT engineers, which offers strength comparable to steel with reduced weight).

### SUMMARY OF THE INVENTION

In accordance with the present invention, a theft-resistant coupling system is provided for use with a trailer having a tongue. The coupling system comprises a hitch receiver that is configured to be capable of receiving a vehicle-engaging member for coupling the trailer to the vehicle. A coupler is receivably matable with the hitch receiver. The coupler includes a proximal portion and a distal portion. A blocking member is coupled to the distal portion that is substantially incapable of being functionally mated to a vehicle-engaging member, thereby preventing the vehicle from safely towing the trailer. A lock is movable between a locked position, in which the lock is coupled to the hitch receiver, and an unlocked position for permitting the coupler to be removed from the hitch receiver.

In a preferred embodiment, the hitch receiver includes a tubular member, and the coupler includes a tubular member for mating with the tubular member of the hitch receiver. The tubular members may be constructed from materials such as steel, galvanized steel, aluminum, or high-strength plastics (e.g., the 2DPA-1 polymer developed by MIT).

In a most preferred embodiment, the hitch receiver includes a lock-receiving portion that comprises an aperture, and the coupler includes a lock-receiving portion that also includes an aperture that is configured to be alignable with the lock-receiving portion of the hitch receiver for enabling the lock to extend through the apertures of the hitch receiver and the coupler for locking them together.

### BRIEF DESCRIPTION OF THE DRAWINGS

In the figures:

FIG. 1 is a perspective view of a trailer tongue incorporating the present invention;

FIG. 1A is a perspective view of a prior art utility trailer;

FIG. 1B is a perspective view of a prior art trailer having a ball hitch mount that is coupled to the trailer ball hitch of a vehicle;

FIG. 1C is an alternate embodiment prior art hitch device known as a pintle hitch, with which the present invention can be employed;

FIG. 2 is a top view showing the tongue member of the present invention and the coupler;

FIG. 3 is an enlarged detailed view taken from detail B of FIG. 2;

FIG. 4 is a top view of the coupler system of the present invention, wherein the coupler member is disengaged from the tongue;

FIG. 5 is a detailed view taken from detail C of FIG. 4 showing the lock in its engaged and locked configuration;

FIG. 6 is a top view showing the hitch receiver and coupler in sections;

FIG. 7 is a view of the hitch receiver and coupler shown in sections;

FIG. 8 is a detailed view taken of detail A of FIG. 7; FIG. 9 is a rear-based perspective view of a trailer tongue and coupler of the present invention, taken from a right-side rear view;

FIG. 10 is a perspective view of the coupler of the tongue and coupler of the present invention taken from a left-front view;

FIG. 11 is a side sectional view of a hitch receiver of the present invention;

FIG. 12 is an end view of the hitch receiver of the present invention;

FIG. 13 is a side sectional view of the coupler member of the present invention;

FIG. 14 is an end view of the coupler member of the present invention showing the distally disposed plug for covering the interior cavity of the tubular coupling member;

FIG. 15 is a top view of the coupler of the present invention;

FIG. 16 is a side sectional view of an alternate embodiment coupler with a hitch-receiver attached, which can be used to couple the trailer to a tow vehicle;

FIG. 17 is a sectional view of the present invention coupler as received by the hitch receiver;

FIG. 18 is a perspective, exploded view of the tongue and coupling system of the present invention;

FIG. 19 is a perspective view of the tongue assembly and coupler of a channel frame trailer;

FIG. 20 is a perspective view of a channel frame and trailer

FIG. 21 is a perspective view of the tongue assembly and coupler of and I-beam frame trailer;

FIG. 22 is a perspective view of an I-Beam frame and trailer; and

FIG. 23 is a perspective view of a gooseneck type trailer.

### DETAILED DESCRIPTION OF THE PREFERRED EMBODIMENT

The description that follows describes, illustrates, and exemplifies one or more particular embodiments of the present invention in accordance with its principles. This description is not provided to limit the invention to the embodiment or embodiments described herein, but rather to explain and teach the principles of the invention in such a way as to enable one of ordinary skill in the art to understand these principles and, with that understanding, be able to apply them to practice not only the embodiment or embodiments described herein, but also other embodiments that may come to mind in accordance with these principles.

The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing reference numbers, such as, for example, in cases where such labeling facilitates a more clear description. Additionally, the drawings set forth herein are not necessarily drawn to scale, and in some instances, proportions may have been exaggerated to more clearly depict certain features. Such labeling and drawing practices do not necessarily implicate an underlying substantive purpose.

Furthermore, certain views are side views which depict only one side of the device (or one set of components of a multi-set array of components), but it will be understood that the opposite side and other component sets are preferably identical thereto. The present specification is intended to be taken as a whole and interpreted in accordance with the principles of the present invention as taught herein and understood by one of ordinary skill in the art.

It should also be appreciated that unless otherwise indicated, terms that relate to directions and placement, including, but not limited to terms such as front, rear, distal, proximal, radial, axial, forward, rearward, above, below, under, over, in front of, behind, and alongside of are provided for illustration to help the reader better visualize the relative placement of the components, and are not intended to be limiting.

For example, the designation of an end or portion of an object as being proximal is in most cases arbitrary and is employed to distinguish its placement from the other end, which may be labeled as distal. Nonetheless, unless otherwise indicated, there is no reason that the formerly labeled distal end could not be labeled the proximal end and vice versa.

Similarly, terms such as radial are employed to distinguish the direction from axial but should not be limited to an interpretation where radial is disposed exactly 90° from axial. Rather, radial should be interpreted as being any direction that is within 45° of a true radial that is perpendicular to axial. Similarly, axial should be interpreted as being any direction that is within 45° of a true axial that is perpendicular to radial.

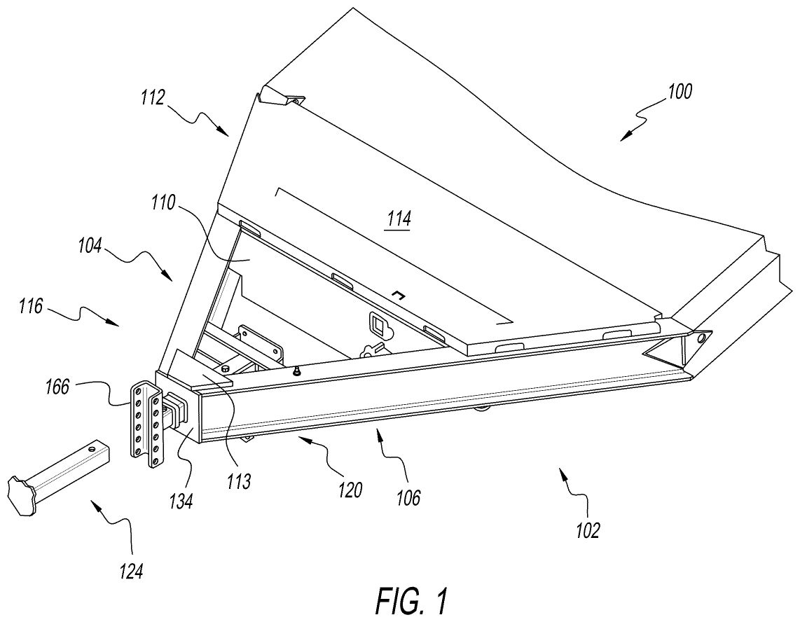

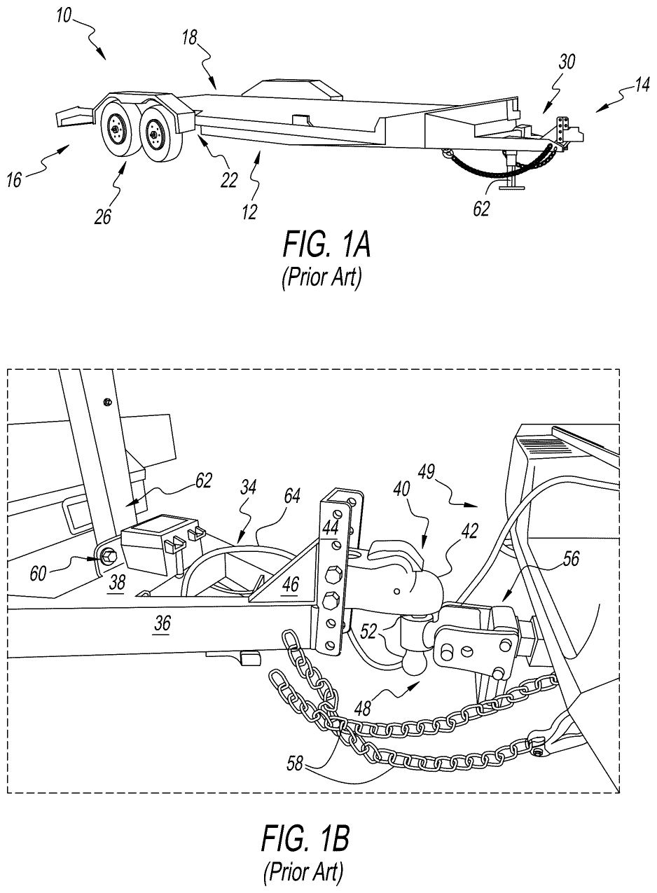

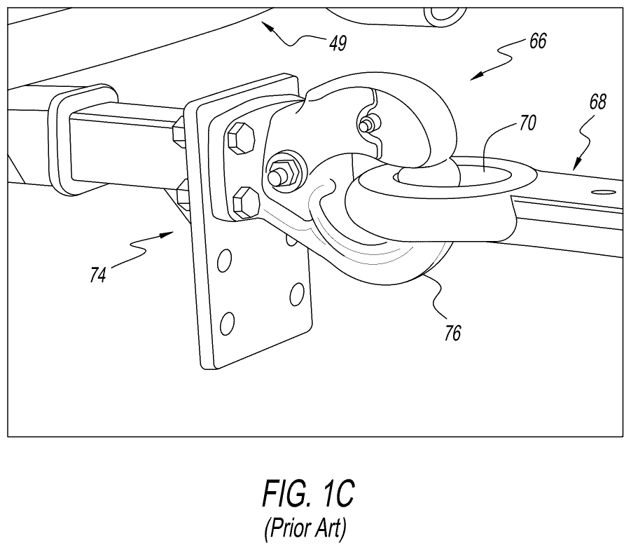

A prior art trailer 10 is shown in FIGS. 1A, 1B, and 1C. The prior art trailer 10 is described herein to provide context for the present invention, to help the reader better understand how the present invention integrates into a typical trailer.

The trailer 10 shown in the drawings is a utility trailer of the type commonly made by Liberty Trailers of Fillmore, Indiana, which company is associated with the inventor of the instant application. The particular trailer 10 shown in the drawings is a flatbed utility trailer that is particularly well adapted to haul cars on its flatbed. Obviously, other objects can be carried on the flatbed of the trailer.

Although a flatbed utility trailer is shown, the invention will also function with other types of trailers, such as cargo trailers, livestock trailers, dump trailers, etc.

Trailer 10 includes a frame 12 having a front end 14 and a rear end 16. A body 18 is coupled onto the frame.

In FIG. 1A, the body 18 is shown as a flatbed body that includes a flatbed that may be made of either a metal material or lumber.

Running gear 22 supports the frame 12 above the ground and enables the frame 12 to move along the ground. The running gear 22 includes an axle, springs, wheels, and ground-engaging tires 26. A tongue assembly 30 is positioned at the front end 14 of the frame.

The tongue assembly 30 includes a first angled frame member 34 and a second angled frame member 36 that are best shown in FIG. 1A. A transverse support member 38 extends transversely between the first and second frame members 34, 36 to provide additional rigidity and support.

A hitch assembly 40 is provided that is coupled to the front of the tongue assembly 30. The hitch assembly 40 includes a ball hitch receiver 42 which includes a ball hitch receiver coupler 44. The ball hitch receiver coupler 44 generally comprises an open-ended spherical member that is sized and configured to interiorly receive trailer balls 52, which are a part of the ball hitch assembly 48 that is coupled to the vehicle 49.

A reinforcing strut 46 is coupled to the ball hitch receiver 42 for reinforcing the ball hitch receiver 42. The ball hitch receiver 42 includes a plurality of apertures, through which bolts or pins can be passed, for coupling the ball hitch receiver 42 to the ball hitch receiver coupler 44. The plurality of apertures are employed so that one can adjust the height of the ball hitch receiver 42 and the ball hitch coupler 44 so that the trailer 10 can be placed in a level orientation.

Various tow vehicles 49 have their hitch members 48 disposed at different heights, and different ball hitch assemblies 48 have different heights. Using the plurality of apertures enables the user to change the height at which the ball hitch receiver coupler 44 is placed on the ball hitch receiver 42.

The ball hitch assembly 48 is coupled to the tow vehicle 49 and includes trailer balls 52 that are sized and configured for being received by the ball hitch receiver coupler 44.

The towing hitch 56 may also include a vehicle-engaging member that enables the ball hitch assembly 48 to engage the vehicle and be removably coupled to different trailer ball 52 configurations.

One or more chains 58 are provided. The chains are generally permanently affixed to the trailer and include hooks, carabiners, or the like at their distal end for coupling to a stationary member of the tow vehicle, such as an eyelet welded to the car frame (not shown). The chains 58 are provided as a back-up connection between the trailer and the towing vehicle, so that if the hitch assembly between the towing vehicle and the trailer becomes dislodged, chains 58 will still maintain a connection between the trailer 10 and the tow vehicle 49 to hopefully help keep them engaged together.

A jack mount 60 is provided on the transverse member 38, to which a jack stand 62 may be attached. The jack stand 62 is preferably one wherein the length of the jack stand 62 can be moved between a ground-engaging position, wherein the base of the jack stand engages the ground, and a travel position, wherein the base of the jack stand 62 is raised above the level of the ground.

The jack stand 62 is used primarily when the trailer 10 is disengaged from the tow vehicle 49 so that the trailer 10 can remain in a level position. Some jack stands 62 are equipped with ground-engaging wheels which enable the trailer 10 to be pushed along the ground without a tow vehicle 49.

Typically, jack stands with casters are found on light-duty trailers, such as boat trailers for small boats which, because of their light weight, can be easily pushed along the ground. An electrical connector 64 is also included as part of a trailer's equipment, which couples the trailer lights of the trailer 10 to the electrical system of the tow vehicle, so that when the user turns his or her lights on or applies the brakes, the trailer lights will light up to warn someone traveling behind the trailer that either the trailer is present or that the trailer and tow vehicle are slowing as the brakes are applied.

A pintle hitch assembly is shown in FIG. 1C. The pintle hitch assembly 66 includes a trailer-engaging coupler 68 that has an eye 70 at its distal end, rather than a ball receiver as is shown in FIGS. 1A and 1B. A vehicle 49 has a pintle-type hitch assembly 74 coupled to it. The pintle hitch assembly 74 includes a pintle-type coupler 76 that engages the eye 70 of the trailer-engaging coupler 68.

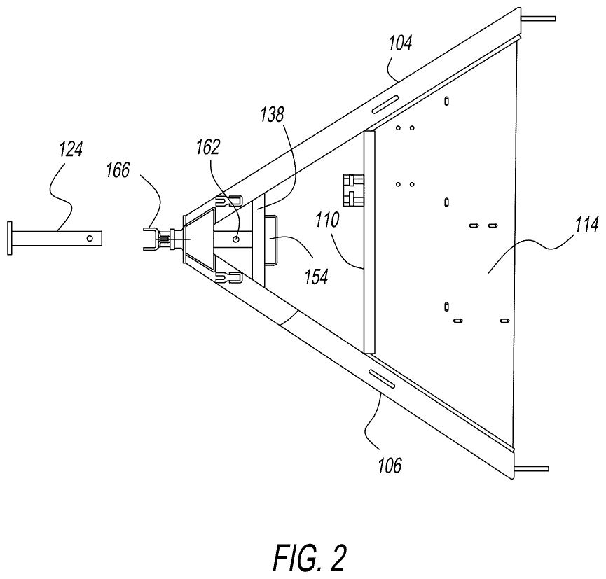

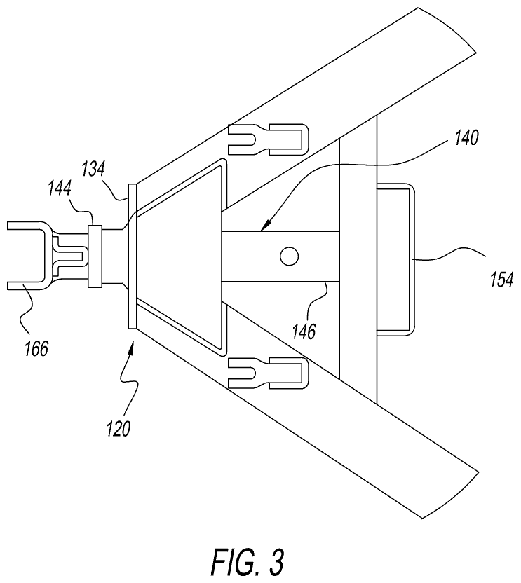

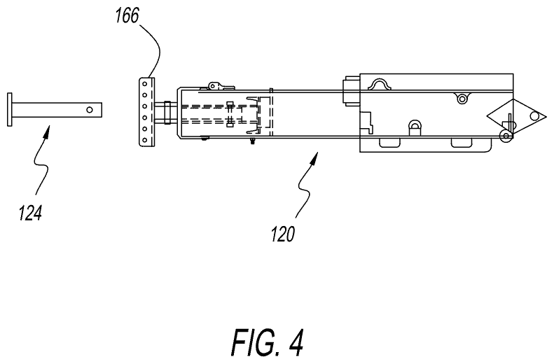

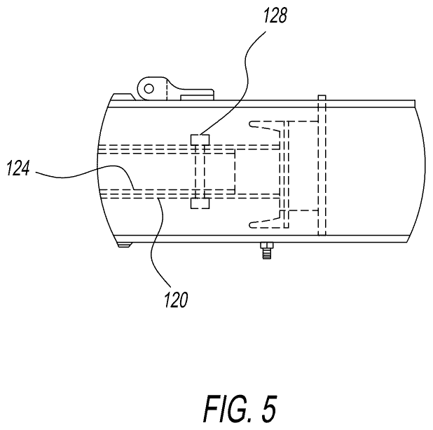

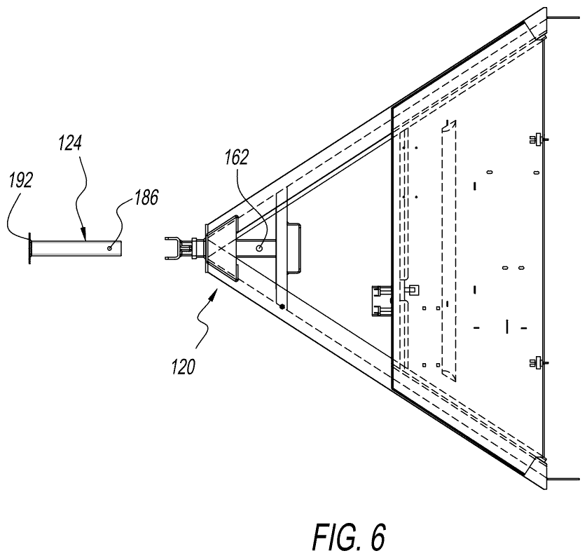

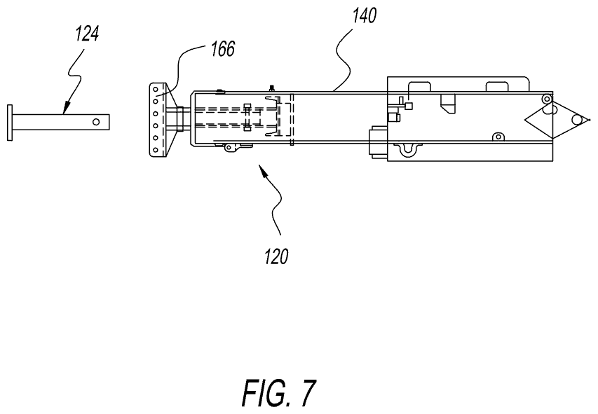

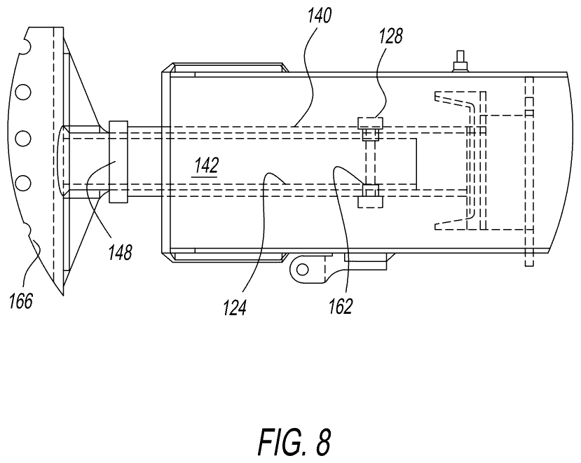

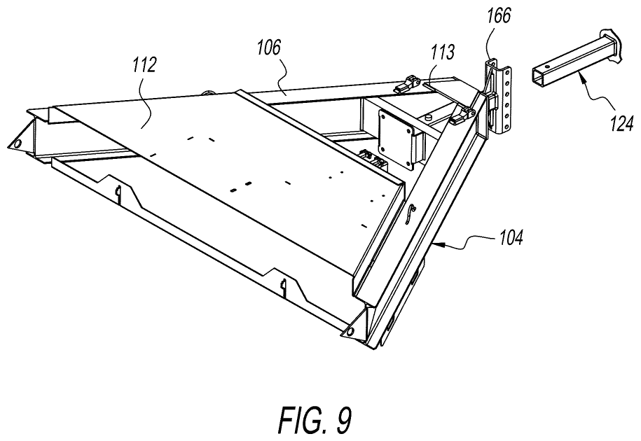

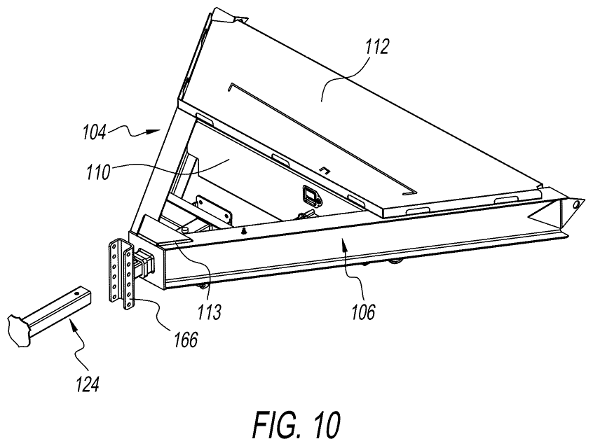

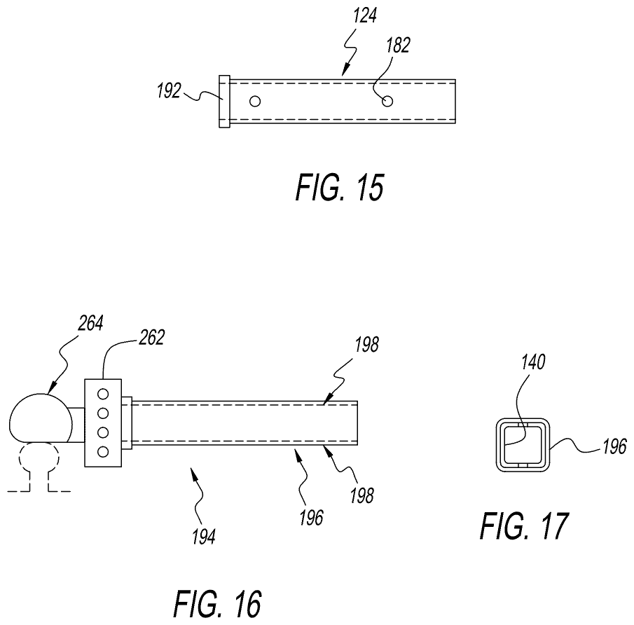

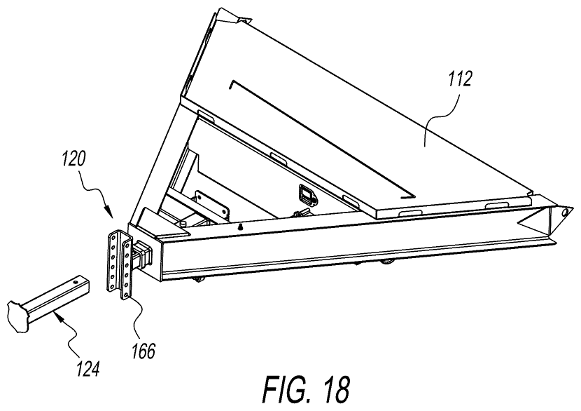

A trailer 100 that embodies the theft-resistant coupler of the present invention is shown in FIGS. 1 and 2-18. The trailer 100 includes a tongue 102 that in many respects is similar to the tongue 30 of the device shown in FIGS. 1A, 1B, and 1C.

The tongue 102 includes a first angled frame member 104 and a second angled frame member 106. The angled frame members 104, 106 include rearward portions that are coupled to the side frame of the trailer 100 and forward portions that are joined together. A mid-positioned transverse reinforcement member 110 extends between the first 104 and second 106 tongue to help provide structural rigidity to the frame, to help prevent the first angled frame member 104 and a second angled frame member 106 from twisting with respect to one another. A reinforced tongue plate 113 is welded to the upper surfaces of the first angled frame member 104 and a second angled frame member 106 to provide further reinforcement to the tongue and coupler

The toolbox assembly 112 is located posteriorly of the transverse reinforcement member. The drawing of the toolbox assembly 112 shows the lid of the toolbox.

The interior of the toolbox 112 would be disposed below the platform (lid) member 112 and extend downwardly and between the angled frame members 104, 106, and preferably be securely coupled thereto to maintain the toolbox assembly 112 in place.

Alternately, item 112 can comprise a platform upon which an item can be securely mounted. Examples of items that can be securely mounted to the platform 112 would include surface-mounted toolboxes for utility trailers, and propane tanks and generators for use with travel trailers such as recreational vehicles or pull-behind trailers.

The theft-resistant coupling assembly 116 includes three primary components, including a hitch receiver assembly 120 that is usually fixedly coupled to the trailer 100 and is configured to receive a vehicle-engaging member for coupling the trailer 100 to the vehicle (not shown), such as vehicle 49 shown in FIGS. 1A-1C.

The second primary component is a removable coupling member 124 that is matable with the hitch receiver 120. The coupler includes a proximal portion 125 that is usually intimately inserted into the hitch receiver assembly 120 and a distal portion which, when in use, extends outwardly from the hitch receiver 120.

The distal portion 126 is configured to be substantially incapable of being functionally mated to a vehicle-engaging member, such as a hitch ball, thereby preventing the vehicle from safely towing the trailer.

In this regard, it can be appreciated that the coupler may be coupled to a vehicle by some jury-rigged device, such as baling wire, chains, or duct tape. Additionally, extraordinary measures might be able to couple the trailer 100 to the vehicle 49, such as through welding the trailer and vehicle hitch ball together or fabricating the parts to join them. However, absent the use of jury-rigged or extraordinary measures, the coupler 124 is not configured to be couplable to a vehicle and moved in a safe manner.

More importantly, one might interpret the term ‘substantially incapable’ as meaning that the coupler cannot be mated to a vehicle with conventional coupling of the type normally and traditionally used to couple vehicles to trailers, such as ball hitches and gooseneck hitches.

As discussed above, the ultimate goal of making a device theft-proof is often not achievable without employing extraordinary and highly expensive methods and devices to prevent the device from being stolen.

Rather, the more realistic goal when making something theft-resistant is to make the device either sufficiently difficult to steal so as to make the theft of the device unattractive to thieves or else to make the device more theft-resistant than similar devices, so as to discourage a thief from stealing the owner's particular device, since someone else's device without a theft-resistant device is much easier to steal and therefore more attractive to steal.

The coupler includes a blocking member, such as a plug or plate 130 that covers the distal end of the coupler 124 to thereby make it more difficult to engage a towing device to the coupler that permits the trailer 100 to be coupled to a vehicle 49 and being towed safely away.

The third primary component of the coupling system is a lock 128 that is movable between a locked position for locking the removable coupling 124 to the hitch receiver 120 and an unlocked position. The lock 128 is movable between a locked position which locks the removable coupler 124 to the hitch receiver assembly 120 and an unlocked position for permitting the coupler 124 to be removed from the hitch receiver assembly 120.

The locking member 128 can comprise something as simple as a locking pin. However, alternately, the locking member can be a shaft-shaped hasp-containing receiver lock that is key-actuated or combination-actuated.

Examples of such receiver locks 128 can be found at [insert URL or reference], that shows these locks are manufactured by Bolt Lock & Strattec Security Corporation of Milwaukee, Wisconsin. Other manufacturers include RINO USA, Metoware, and Master Lock, all of whose products are available at Amazon.com.

As will be described in more detail below, the lock 128 is movable between a locked and an unlocked position. The lock 128 is insertable into apertures which extend through each of the coupler member 124 and hitch receiver 120, to prevent movement of the coupler 124 and hitch receiver 120 with respect to each other.

To ensure that the lock 128 remains in position, the lock can be actuated, via a key or combination mechanism, to go into its locking position. When in the locking position, the lock 128 cannot be removed from the apertures without again being unlocked by the key or combination mechanism.

When one seeks to remove the removable coupling 124, one would use the key to move the lock from its locked position to an unlocked position. When in the unlocked position, the pin-like lock 128 can be removed from the apertures, which permits the coupler 124 and hitch receiver 120 to be separated from each other.

The hitch receiver assembly 120 includes a blocking member such as a front plate 134 that is disposed at the front of the trailer 100, where the first 104 and second 106 angled members meet. The plate 134 is forwardly facing and includes an aperture for receiving a hitch receiver tube 140.

Preferably, the hitch receiver tube 140 is welded to the front plate 134 or otherwise securely attached, so that the front plate 134 serves as a support for the hollow tube 140. A second, transverse support member 138 extends in a plane generally parallel to the front plate 134 and is positioned near the proximal portion 146 of the hollow receiver tube 140.

Similar to the front plate 134, the transverse support member 138 contains an aperture through which the proximal portion 146 of the hollow tube 140 passes. The hollow hitch receiver tube 140 should be welded to the transverse support, so that the transverse support can serve as a second source of support for the hollow hitch receiver tube 140.

Between the front plate 134 and the second transverse support 138, the hollow tube has two support members to keep it firmly supported, and to keep it securely coupled to the trailer 100. The hitch receiver tube 140 comprises a hollow tube having an interior passageway 142.

In the preferred embodiment shown in the drawing, the coupler receiver tube 140 has a generally square cross-section of a certain area. A square tube cross-section is shown and employed both because it resists rotating about its longitudinal axis, as a cylindrical tube would, and also because of its availability. Square steel tubing is being used in a wide variety of applications and can be easily purchased by a manufacturer as an off-the-shelf item, which thereby spares the manufacturer the need to purchase tooling to provide a custom tube.

Although a square tube 140 is shown, it will be appreciated that tubes having other cross-sectional shapes will also be usable, such as a rectangular tube, pentagonal tube, hexagonal tube, ovaloid tube, or the like.

The hitch receiver tube 140 and associated components may be constructed from various materials, including steel, galvanized steel, aluminum, or high-strength plastics such as the 2DPA-1 polymer developed by MIT, to suit different trailer requirements for weight, durability, and corrosion resistance.

The hollow tube 140 has a distal portion 144 that is disposed adjacent to the front plate 134 and a proximal portion 146 that is disposed adjacent to the transverse support member 138. The hollow tube includes an open distal end, through which the coupler may be inserted, and a closed proximal end.

A plug is applied to the proximal end to close off the hollow interior passageway 142 at the proximal end. This prevents anything from being inserted in the proximal end that would be capable of serving as a coupling mechanism to couple the trailer 100 to a tow vehicle. Preferably, the plug 154 comprises a plate 154 that is welded to the proximal end of the hollow tube 140 or, otherwise, is welded to the trailing side of the transverse support 138 in a position wherein the plate 154 is close enough to the proximal end of the hollow tube so that no hitch device can be inserted.

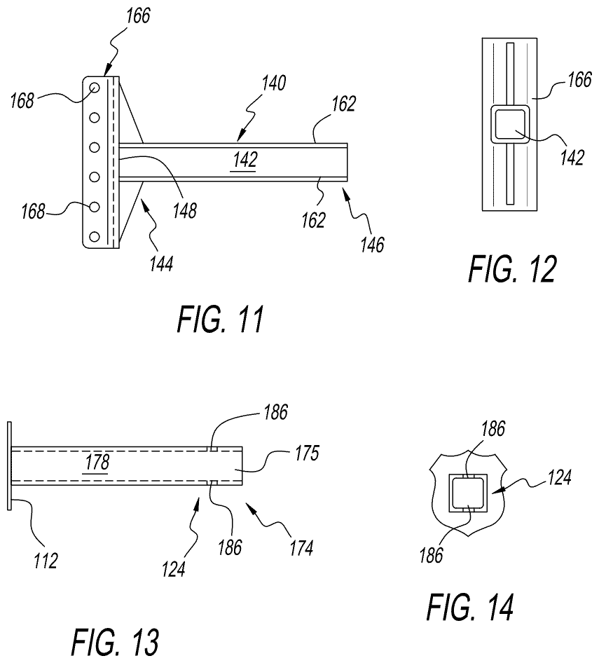

The hollow tube 140 with the hollow interior 142 is well shown in FIG. 11 as including a pair of aligned lock-receiving apertures 162. As will be discussed in more detail below, the lock-receiving apertures 162 are sized, configured, and positioned to be alignable with similar lock-receiving apertures in the removable coupler 124.

A coupler-engaging bracket 166 is coupled to the distal end portion 144 of the hollow tube 140, adjacent to the open distal end 148 of the coupler. The coupler-engaging bracket generally comprises a C-shaped bracket having a plurality of apertures 168. The plurality of apertures are sized and positioned for receiving bolts or screws to which a hitch coupling member can be mounted, such as a ball-receiving member, such as that shown in FIGS. 1A-1C.

The removable coupler 124 is shown well in FIGS. 1 and 11 as comprising a hollow tube having a cross-sectional area wherein the outer diameter of the removable coupler 124 is slightly smaller than the inner diameter of the hollow tube 140 of the hitch receiver. This permits the removable coupler 124 to be slidably interiorly received within the hitch receiver 140.

The removable coupler 124 includes a proximal end 174 which, in practice, is interiorly inserted within the hollow tube 140 of the hitch receiver. The coupler 124 includes an opening at the proximal end as the open end. In use, the opening at the proximal end is covered by the plug at the end of the hollow tube receiver 140.

However, the opening 175 can be plugged or covered over as desired by the user or manufacturer. The removable coupler 124 also includes a distal end 176.

A hollow interior passageway 178 extends between the proximal end 174 and the distal end. A plug such as plate 182 is fixedly coupled, such as by welding, to the distal end 176, to cover the distal end, so that no item, such as a hitch ball, may be inserted into the hollow end.

The removable coupler 124 also includes a pair of aligned apertures 186 that are disposed closer to the proximal end 174 than the distal end 176. The apertures 186 are sized, configured, and positioned to be alignable with the apertures 162 of the hitch tube 140.

The apertures 162 and 186 are alignable to receive a lock mechanism 128, such as is described above which comprises a receiver lock pin 128 or the like.

When the coupler 124 is inserted within the hollow tube 140 and the apertures 162, 186 are aligned, the lock 128 can be inserted through the apertures 162, 186 to fixedly position the coupler 124 and the hitch 140 together. If a key- or combination-actuable lock 128 is provided, the lock 128 can be then placed in its locking position to prevent the hitch tube 140 and coupler 124 from being separated without the use of extraordinary means.

The plate 192 on the distal end of the coupler 124 should be sized to be large enough to partially cover the channel formed between the pair of flanges of the bracket 166 of the hitch receiver, to thereby block someone from placing a hitch member-engaging device, such as a ball receiver, and coupling it to the bracket 166 and thereby to the hitch receiver.

An alternate embodiment coupler 194 is shown in FIG. 16. Coupler 194 incorporates the ball-receiving bracket 202 onto the coupler 194, to thereby obviate the need for the bracket 202 on the hitch receiver. This embodiment may have the advantage of making the device more theft-resistant by removing a bracket 202 that can be attached to a ball receiver 204 from the hitch receiver.

Alternate embodiment coupler 194 includes a hollow tube 196 having a pair of lock-receiving apertures 198 that are positioned similarly to their position on coupler 124. At the distal end of the coupler is a bracket 202 that is similar to bracket 166 on the embodiments discussed above. However, rather than the ball-receiving bracket 202 being attached to the hitch receiver, it is attached to the coupler 194.

As such, when coupler 194 is not attached to the trailer, there would be no bracket 202 for mounting a ball receiver 204.

Coupler 194 is not intended to be used when the trailer is in its theft-resistant mode so that theft-resistant coupler 124 is used for deterring theft. Rather, coupler 194 would be an additional coupler that would supplement coupler 124 and is used when the trailer 100 owner desires to tow the trailer by hitching it to a vehicle.

When a trailer is parked and placed in its theft-resistant mode, normal coupler 124 would be attached to the hitch receiver of the trailer 100. However, when the user wishes to move the trailer, he or she would remove the theft-resistant coupler 124 and insert in its place a trailer-movable coupler 194. As a trailer-movable coupler 194, the coupler 194 has a ball receiver 204 that can be coupled to it. The user could then use the coupler 194 to tow the trailer 100.

An additional feature is that the coupler 194 could be provided with a plurality of apertures along the length of the hollow tube, so that the user could vary the effective length of the coupler 194 to increase the distance between the bracket 202 and the ball receiver 204 or decrease it as desired.

Having described the invention in detail with certain preferred embodiments, it will be appreciated that variations and modifications exist.

The tongue 102 and coupling system components may be adapted for various structural configurations of the tongue, including tubular, channel, I-beam, or box-section designs, and constructed from materials such as steel, galvanized steel, aluminum, or high-strength plastics like MIT's 2DPA-1 polymer, to optimize for different trailer applications while preserving the theft-resistant functionality.

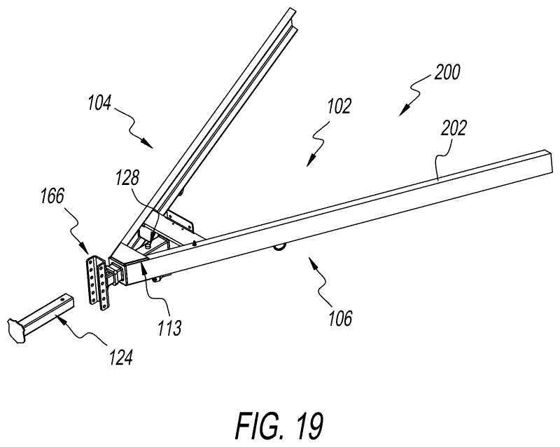

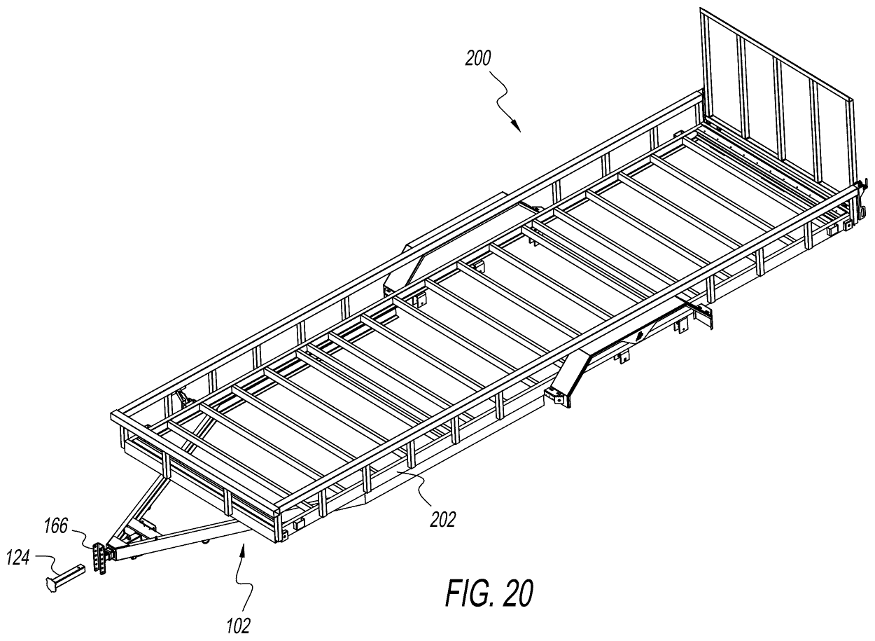

FIGS. 19 and 20 show prospective views of channel frame type trailers. The channel type trailer 200 includes a channel frame 202, to which a tongue 102 is coupled. The tongue 102 includes a coupler 104 and a hitch receiver 148.

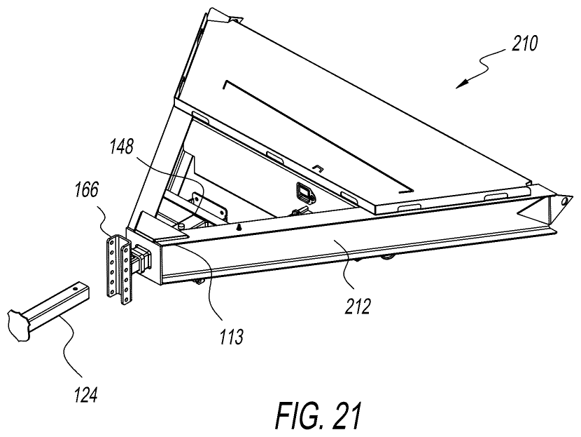

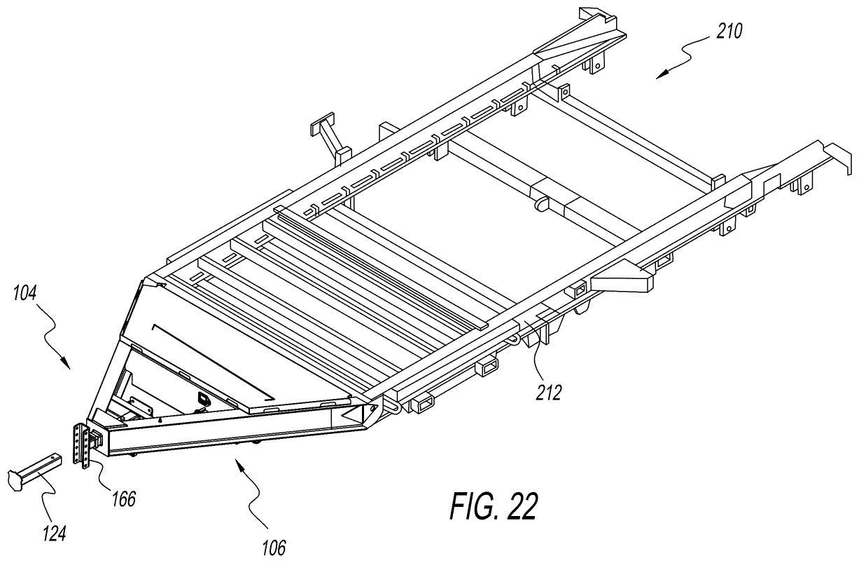

FIGS. 21 and 22 show prospective views of I-beam type trailers. The I-beam type trailer 210 includes an I-beam type frame 212 and includes a tongue 102 at the forward end to which the present invention is coupled, including a hitch receiver and a coupler 124.

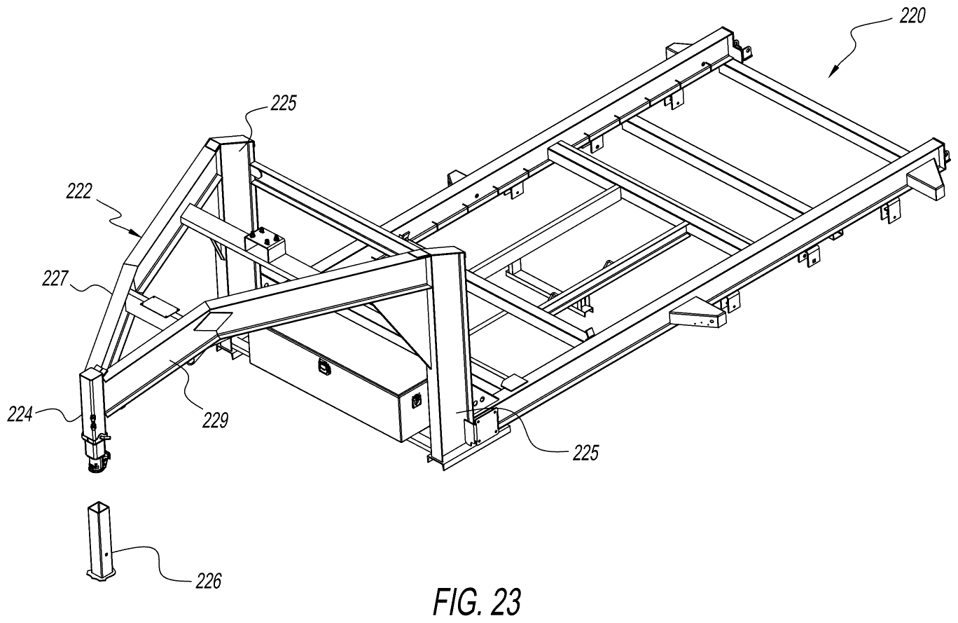

FIG. 23 shows a perspective view of a gooseneck type trailer. Gooseneck type trailer 220 includes a gooseneck heavy-duty tongue assembly 222 which includes upright members 225 in addition to the laterally extending members 227, 229. The hitch receiver 224 is vertically oriented, to receive a vertical he oriented coupler member 226. As will be appreciated, the vertically oriented coupler member 226 only assumes its vertical orientation when it is coupled to the vertical hitch receiver 224, which is fixedly coupled to the trailer 220.

What is claimed is:

1. A theft-resistant coupling system for use with a trailer having a tongue comprising:
a hitch receiver configured to receive a vehicle-engaging member for coupling the trailer to a vehicle;
a coupler receivably matable with the hitch receiver, the coupler including a proximal portion and a distal portion,
a blocking member coupled to the distal portion that is substantially resistant to being functionally mated to a vehicle-engaging member for preventing the trailer from being moved safely with conventional towing hardware, and
a lock movable between a locked position for locking the coupler to the hitch receiver and an unlocked position for permitting the coupler to be removed from the hitch receiver.

2. The coupling system of claim 1 wherein the hitch receiver includes a tubular member, and the coupler includes a tubular member for mating with the tubular member of the hitch receiver.

3. The coupling system of claim 2 wherein the tubular member of the coupler is interiorly received by the tubular member of the hitch receiver.

4. The coupling system of claim 2 wherein the hitch receiver includes a lock-receiving portion, and the coupler includes a lock-receiving portion, wherein the lock engages the lock-receiving portion of the hitch receiver and the lock-receiving portion of the coupler for locking together the hitch receiver and the coupler to prevent them from being separated.

5. The coupling system of claim 4 wherein the lock comprises one of a key-actuable lock and a combination-actuable lock for moving the lock between a locked and an unlocked position.

6. The coupling system of claim 5 wherein the lock includes a hasp having a linear portion configured for extending through an aperture in each of the hitch receiver and the coupler.

7. The coupling system of claim 4 wherein the lock-receiving portion of the hitch receiver comprises an aperture, and the lock-receiving portion of the coupler comprises an aperture configured to be alignable with the lock-receiving portion of the hitch receiver, wherein the lock passes through the lock-receiving portion of the coupler and the lock-receiving portion of the hitch receiver to lockably couple the hitch receiver and the coupler.

8. The coupling system of claim 4 wherein the lock comprises one of a key-actuable and a combination-actuable lock for moving the lock between a locked and an unlocked position, wherein the lock includes a hasp having a linear portion for extending through the aperture in each of the coupler and hitch receiver.

9. The coupling system of claim 8 wherein the tubular member of the coupler includes a proximal end engageable with the hitch receiver, a distal portion having a blocking member, and a hollow interior passageway, wherein the blocking member comprises a plug coupled to and placeable over the hollow interior passageway for preventing a coupling device from being inserted into the hollow interior passageway.

10. The coupling system of claim 10 wherein the plug comprises a plate fixedly coupled to the distal end of the coupler, the plate having an area greater than the cross-sectional area of the interior passageway.

11. The coupling system of claim 1 wherein the lock comprises a locking pin, the hitch receiver includes a lock-receiving aperture, and the coupler includes a lock-receiving aperture configured for being placed in alignment with the lock-receiving aperture of the hitch receiver for enabling the locking pin to extend through the lock-receiving apertures of both the hitch receiver and the coupler.

12. The coupling system of claim 11 wherein the hitch receiver includes a proximal portion for receiving the coupler and a proximal end coupled to the trailer tongue, and a hollow interior portion, further comprising a plug coupled to the proximal end for preventing the insertion of a vehicle-engaging coupler in the hollow interior.

13. The coupling system of claim 12 wherein the plug comprises a plate permanently coupled to the proximal end of the hitch receiver, and having an area greater than the cross-sectional area of the interior passageway.

14. The coupling system of claim 13 wherein the plate is welded to the proximal end of the hitch receiver.

15. The coupling system of claim 14 wherein the hitch receiver is positioned at a forward portion of the tongue, and wherein the tongue includes a first tongue frame member and a second tongue frame member, further comprising a first reinforcing member coupled to the first tongue frame member, the second tongue frame member, and the hitch receiver.

16. The coupling system of claim 1 wherein the hitch receiver includes a proximal portion coupled to the tongue and a distal portion configured for receiving a proximal end of the coupler, and a hollow interior, further comprising a plug fixedly coupled to the proximal portion of the hitch receiver for preventing the insertion of a vehicle-engaging coupler into the hollow interior.

17. The coupling system of claim 16 wherein the plug comprises a plate welded to the proximal portion of the hitch receiver, the plate having an area greater than the cross-sectional area of the hollow interior.

18. The coupling system of claim 1 further comprising a tow bar assembly configured for coupling the trailer to a vehicle for enabling the vehicle to move the trailer, the tow bar assembly including a tow bar coupler removably matable with the hitch receiver for coupling the tow bar assembly to the hitch receiver.

19. The coupling system of claim 18, wherein the tow bar coupler includes a tubular bar receivable by the hitch receiver, a lock for locking the hitch receiver to the tubular bar of the tow bar assembly, and a hitch ball receiver configured for being coupled to a hitch ball of a vehicle.

20. The coupling system of claim 19, wherein the hitch receiver includes an aperture, and the tubular bar includes an aperture configured to be alignable with the aperture of the hitch receiver for receiving a locking pin for locking together the hitch receiver and the tow bar assembly.

21. The coupling system of claim 1, wherein the coupler comprises one of a ball hitch coupler, a pintle coupler, and a gooseneck coupler.

22. The coupling system of claim 1, wherein the tongue comprises a structural member selected from the group consisting of tubular, channel, I-beam, and box-section configurations, and is made from a material selected from the group consisting of steel, galvanized steel, aluminum, and high-strength plastics.
